(19) United States
(12) Patent Application Publication
(10) Pub. No.: US 2025/0314785 A1
(43) Pub. Date: Oct. 9, 2025

(54) RADIOGRAPHIC IMAGING APPARATUS

(71) Applicant: Konica Minolta, Inc., Tokyo (JP)

(72) Inventors: Mina TSUCHIZAWA, Asaka-shi (JP); Junichiro OTAKI, Tokyo (JP); Hajime ISHIMOTO, Tokyo (JP)

(21) Appl. No.: 19/171,495

(22) Filed: Apr. 7, 2025

(30) Foreign Application Priority Data
Apr. 9, 2024 (JP) 2024-062476

(51) Int. Cl. G01T 1/20

(52) U.S. Cl. CPC G01T 1/20188; G01T 1/2006

(57) ABSTRACT

A radiographic imaging apparatus includes: a housing having an irradiation part to be irradiated with radiation; an internal module including a radiation detector that detects the radiation, and a holding base that is made of metal and holds the radiation detector; and a peeling aid having a bending rigidity lower than a bending rigidity of the internal module and disposed between the internal module and the irradiation part. The radiation detector includes: a scintillator; a light detector having a light receiving surface on which a light receiving element and a line for reading out an electric signal from the light receiving element are formed; and a support that supports the light detector. The peeling aid is provided on, of the internal module, an entire surface closer to the irradiation part, and fixed to an inner surface of the irradiation part by an adhesive member to be peelable.

### CROSS-REFERENCE TO RELATED APPLICATIONS

The present invention claims priority under 35 U.S.C. § 119 to Japanese Patent Application No. 2024-062476, filed on Apr. 9, 2024, the entire content of which is incorporated herein by reference.

### BACKGROUND OF THE INVENTION

### Technical Field

The present invention relates to a radiographic imaging apparatus.

### Description of Related Art

In recent years, a portable (which may be referred to as a cassette type or the like) radiographic imaging apparatus that can be separated from an imaging table and carried has been developed and put into practical use. Since such a radiographic imaging apparatus has a panel shape, it may be referred to as a flat panel detector (FPD).

The FPD includes an internal module including a radiation detection section that detects radiation and a holding base that holds the radiation detection section. The internal module is attached to the housing of the FPD.

In a case where an internal module or a housing is replaceable in an FPD, the FPD includes a peeling aid for separating the internal module and the housing (e.g., Japanese Unexamined Patent Publication No. 2022-129074 and Japanese Patent No. 5647581).

### SUMMARY OF THE INVENTION

The peeling aid may be provided at a position to overlap the radiation detection section in the front-back direction of the FPD for the following reason(s). The position to overlap the radiation detection section is, for example, an effective image region in the radiation detection section (region appearing in a captured image). It is because, in order to prevent the peeling aid from being pulled out from the radiation detection section when the internal module and the housing are separated, an attachment area for providing a sufficient shear adhesive force is required between the peeling aid and the layer of the radiation detection section. The attachment area is determined by the adhesive force of the interface to be peeled and the adhesive force of the adhesive material used for the peeling aid.

In a case where the peeling aid is provided at the position to overlap the radiation detection section in the front-back direction of the FPD, and the holding base is formed of metal in order to maintain the rigidity of the FPD, the following problem(s) may occur. Specifically, when a load is applied to the front surface part of the housing of the FPD, the radiation detection section is locally bent by the peeling aid, but since the metallic holding base has high rigidity, the bending of the radiation detection section cannot be absorbed. As a result, a local step is generated in the radiation detection section due to the bending, and thus disturbance (image unevenness) occurs in an image generated by the FPD. If local bending repeatedly occurs in the radiation detection section, the radiation detection section may be damaged.

The present invention has been made in view of the above-described problems, and an object of the present invention is to provide a radiographic imaging apparatus capable of suppressing occurrence of image unevenness and preventing damage to a radiation detection section thereof.

To achieve at least one of the abovementioned objects, according to an aspect of the present invention, a radiographic imaging apparatus reflecting one aspect of the present invention includes:
a housing having an irradiation part to be irradiated with radiation;
an internal module including:
   a radiation detector that detects the radiation; and
   a holding base that is made of metal and holds the radiation detector; and
a peeling aid having a bending rigidity lower than a bending rigidity of the internal module and disposed between the internal module and the irradiation part,
wherein the radiation detector includes:
   a scintillator;
   a light detector having a light receiving surface on which a light receiving element and a line for reading out an electric signal from the light receiving element are formed; and
   a support that supports the light detector, and
wherein the peeling aid is provided on, of the internal module, an entire surface closer to the irradiation part, and fixed to an inner surface of the irradiation part by an adhesive member to be peelable.

According to an aspect of the present invention, a radiographic imaging apparatus reflecting one aspect of the present invention includes:
a housing having an irradiation part to be irradiated with radiation;
an internal module including:
   a radiation detector that is fixed to an inner surface of the irradiation part by an adhesive member to be peelable and detects the radiation; and
   a holding base that is made of metal and holds the radiation detector; and
a peeling aid disposed between the internal module and the irradiation part,
wherein the radiation detector includes:
   a scintillator;
   a light detector having a light receiving surface on which a light receiving element and a line for reading out an electric signal from the light receiving element are formed; and
   a support that supports the light detector,
wherein the peeling aid is provided on, of the internal module, a part of a surface closer to the irradiation part, and
wherein a thickness of the peeling aid is less than a thickness of the adhesive member.

According to an aspect of the present invention, a radiographic imaging apparatus reflecting one aspect of the present invention includes:
a housing having an irradiation part to be irradiated with radiation;
an internal module including:
   a radiation detector that is fixed to an inner surface of the irradiation part by an adhesive member to be peelable and detects the radiation; and
   a holding base that is made of metal and holds the radiation detector; and
a peeling aid disposed between the internal module and the irradiation part,
wherein the radiation detector includes:
   a scintillator;
   a light detector having a light receiving surface on which a light receiving element and a line for reading out an electric signal from the light receiving element are formed; and
   a support that is made of glass and supports the light detector,
wherein the peeling aid is provided on, of the internal module, a part of a surface closer to the irradiation part, and
wherein a thickness of the peeling aid is less than half of a thickness of the support.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein: FIG. 1 is a perspective view illustrating the front surface and part of the lateral surface of a radiographic imaging apparatus;

FIG. 2 is a schematic diagram of a section along line II-II of the radiographic imaging apparatus of FIG. 1 according to a first embodiment;

FIG. 3 is a partial sectional view III of FIG. 2;

FIG. 4 is a plan view illustrating the configuration of a surface of an element substrate;

FIG. 5A is a lateral surface sectional view illustrating an example of a state in which the internal module is peeled off from the housing;

FIG. 5B is a lateral surface sectional view illustrating an example of the state in which the internal module is peeled off from the housing;

FIG. 6 is a schematic view of a section along line II-II of the radiographic imaging apparatus of FIG. 1 according to a second embodiment;

FIG. 7 is a partial sectional view VII of FIG. 6;

FIG. 8 is a table illustrating a relationship between the thickness of the peeling aid and the thickness of an element substrate;

FIG. 9A is a partial sectional view VII of FIG. 6 according to a fifth embodiment; and

FIG. 9B is a partial sectional view VII of FIG. 6 according to the fifth embodiment.

### DETAILED DESCRIPTION

Hereinafter, embodiments of the present invention will be described with reference to the drawings. However, the scope of the invention is not limited to the disclosed embodiments.

### First Embodiment

Hereinafter, a schematic configuration of a radiographic imaging apparatus 100 according to a first embodiment will be described.

The radiographic imaging apparatus 100 generates a radiation image corresponding to received radiation.

### 1. Housing

The radiographic imaging apparatus 100 includes a housing 110 having a rectangular shape in plan view. FIG. 1 is a perspective view illustrating the front surface 110a on which radiation is incident and part of the lateral surface 110c of the housing 110. The surface opposite to the front surface 110a of the housing 110 is referred to as a back surface 110b.

In FIG. 1, the X-axis direction is the direction parallel to the short sides of the housing 110. The Y-axis direction is the direction parallel to the long sides of the housing 110. The Z-axis direction (front-back direction) is the thickness direction of the housing 110. The direction of the arrow of each axis is a plus (positive) direction. That is, in the X-axis direction, a side where a connector 51, an antenna 56 and an operation part 57, which will be described later, are provided is a minus (negative) direction. In the Y-axis direction, a direction from the antenna 56 toward the connector 51 is a plus (positive) direction. In the Z-axis direction, a direction from the back surface 110b toward the front surface 110a is a plus (positive) direction.

As illustrated in FIG. 1, the lateral surface 110c of the housing 110 includes a connector 51, an antenna 56, and an operation part 57.

The connector 51 supplies power from the outside by wired connection and communicates with the outside.

The antenna 56 performs wireless communication with an external apparatus.

The operation part 57 is a switch such as a power switch or a changeover switch.

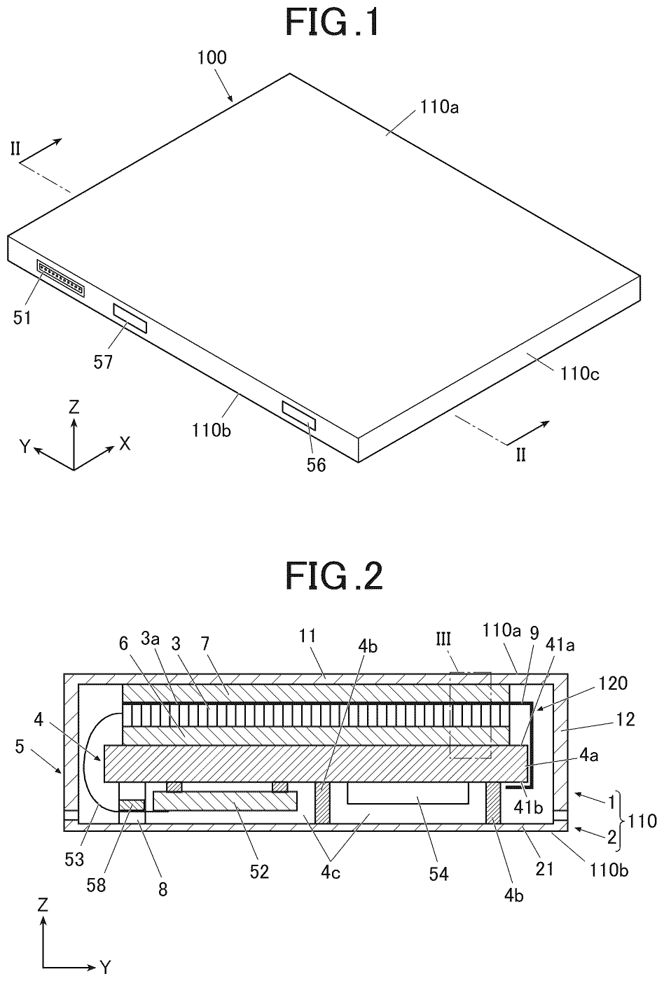

FIG. 2 is a schematic view of a section along line II-II of the radiographic imaging apparatus 100 illustrated in FIG. 1.

As illustrated in FIG. 2, the housing 110 includes a case 1 and a lid 2, and has a rectangular panel shape. The housing 110 houses an internal module 120.

The case 1 is formed of a material that transmits radiation. For example, the material of the case 1 is carbon fiber reinforced plastic (CFRP) containing short fibers. Since the carbon fiber reinforced plastic has high radiation transmittance, the radiation transmitted through a subject reaches the internal module 120 without being attenuated on the way. Therefore, the image quality of the radiation image can be higher than in the case where the case 1 is formed of another material.

The lid 2 may be formed of the same material as that of the case 1 but may be formed of a material such as aluminum, magnesium or an alloy thereof having excellent electrical conductivity and thermal conductivity.

### 1-1. Case

As illustrated in FIG. 2, the case 1 has a front surface part 11 and a lateral surface part 12. The front surface part 11 is an irradiation part to be irradiated with radiation. The front surface part 11 and the lateral surface part 12 are integrally formed. The front surface part 11 and the lateral surface part 12 may be individual members.

### 1-1-1. Front Surface Part

The front surface part 11 spreads parallel to a radiation detection section 3 (radiation detector). The outer surface of the front surface part 11 is a radiation incident surface 110a (front surface) of the radiographic imaging apparatus 100 (housing 110). The front surface part 11 is formed in the shape of a rectangular plate.

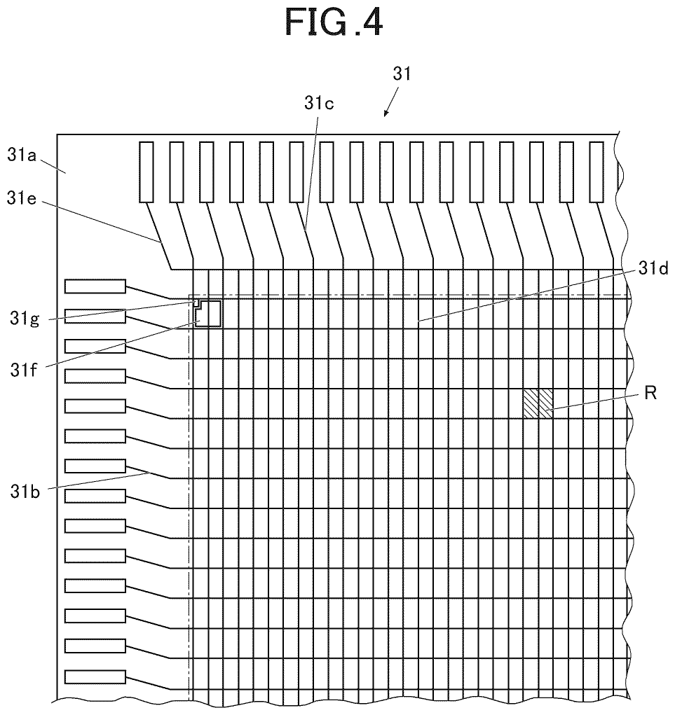

On the radiation incident surface 110a, an effective image region of the radiation detection section 3 is indicated by a frame (not illustrated). The effective image region of the radiation detection section 3 is a region in which photoelectric conversion elements 31f in FIG. 4) are arranged.

### 1-1-2. Lateral Surface Part

The lateral surface part 12 extends from the peripheral edge of the front surface part 11 in a direction orthogonal to the radiation incident surface 110a and in which the back surface part 21 exists (negative direction of the Z-axis). The outer surface of the lateral surface part 12 is the lateral surface 110c of the radiographic imaging apparatus 100 (housing 110).

### 1-2. Lid

As illustrated in FIG. 2, the lid 2 has a back surface part 21. The lid 2 according to the present embodiment is the back surface part 21 entirely. The back surface part 21 faces the front surface part 11 of the case 1 with the internal module 120 in between, and spreads in parallel with the front surface part 11. The outer surface of the back surface part 21 is the back surface 110b of the radiographic imaging apparatus 100 (housing 110).

The lid 2 (back surface part 21) abuts the lateral surface part 12 of the case 1 and is attached to the lateral surface part 12. Thus, the lateral surface part 12 connects the front surface part 11 and the back surface part 21.

The lid 2 according to the present embodiment is screwed to the case 1. Therefore, when the radiographic imaging apparatus 100 is repaired or maintained, the back surface part 21 can be separated from the front surface part 11 and the lateral surface part 12 only by loosening and removing the screws. That is, a person who maintains the radiographic imaging apparatus 100 can easily access the internal module 120 stored by the front surface part 11 and the lateral surface part 12. When the lid 2 and the case 1 are screwed together, parts of the screw heads visible from the outside may be covered with a resin film, an elastic body, or the like. Thus, it is possible to prevent parts of the screw heads visible from the outside from rusting or becoming dirty due to external moisture.

The housing 110 may be configured to be waterproof and dustproof by interposing a gasket such as an O-ring or a waterproof cushion material between the lid 2 and the case 1 and fixing them with screws or bonding them together. Since moisture does not enter the inside of the housing 110, it is possible to prevent moisture from affecting the radiation detection section 3 and an electric component 5 (described later). When the lid 2 and the case 1 are bonded to each other, a gasket between the lid 2 and the case 1 is not required, and the waterproofness can be improved as compared with the case where the lid 2 and the case 1 are screwed to each other with a gasket interposed therebetween.

### 1-3. Others

FIG. 2 illustrates the housing 110 (case 1) in which the lateral surface part 12 is formed integrally with the front surface part 11. However, the housing 110 may be configured such that the lateral surface part 12 is integrated with the back surface part 21, or the front surface part 11, the lateral surface part 12 and the back surface part 21 are individual members.

### 2. Internal Module

The internal module 120 includes the radiation detection section 3, a holding base 4, the electric component 5, a vibration damping member 8, and a peeling aid 9.

### 2-1. Radiation Detection Section

As illustrated in FIG. 2, the radiation detection section 3 is fixed to the holding base 4 by a first adhesive member 6. The radiation detection section 3 is fixed to the front surface part 11 of the housing 110 by a second adhesive member 7 via the peeling aid 9. In other words, the internal module 120 is fixed to the front surface part 11 of the housing 110 by the second adhesive member 7.

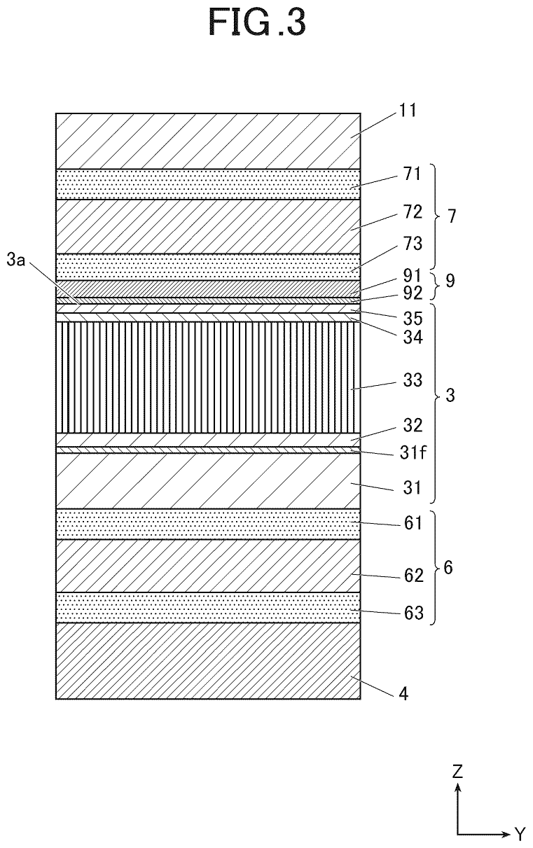

FIG. 3 illustrates a partial sectional view III of FIG. 2.

As illustrated in FIG. 3, the radiation detection section 3 includes an element substrate 31 (support), an optical adhesive layer 32, a scintillator 33, a scintillator substrate 34, and a moisture-proof layer 35.

The element substrate 31 is formed of a glass substrate and has photoelectric conversion elements and the like arranged on the glass substrate. The element substrate 31 may be formed of a substrate other than a glass substrate, the substrate transmitting light such as radiation or ultraviolet rays. For example, the element substrate 31 may be formed of a flexible material. Examples of the flexible material include polyethylene naphthalate, polyethylene terephthalate (PET), polycarbonate (PC), polyimide, polyamide, polyetherimide, aramid, polysulfone, polyethersulfone, fluororesin, polytetrafluoroethylene (PTFE), and a composite material in which at least two or more of these are mixed. In particular, among the above materials, polyimide, polyamide, polyetherimide, PTFE, or a composite material thereof is preferable from the viewpoint of improving heat resistance.

FIG. 4 is a plan view illustrating the configuration of a surface of the element substrate 31. On the front surface 31a of the element substrate 31, scanning lines 31b and signal lines 31c are arranged so as to intersect with each other. The front surface 31a is a surface facing the scintillator 33 via the optical adhesive layer 32. Bias lines 31d are arranged parallel to the signal lines 31c. In the present embodiment, the bias lines 31d are tied together by one connection line 31e at one end on the element substrate 31.

A photoelectric conversion element 31f is provided in each of small regions R partitioned by the scanning lines 31b and the signal lines 31c on the front surface 31a of the element substrate 31. As described above, in the present embodiment, the photoelectric conversion elements 31f are two dimensionally arranged and formed on the front surface 31a of the element substrate 31. The photoelectric conversion elements 31f are connected to the bias lines 31d. In the present embodiment, a bias voltage is applied to the photoelectric conversion element 31f from a bias power source (not illustrated) via the bias line 31d.

In the present embodiment, as the photoelectric conversion elements 31f, photodiodes are used. The photodiodes are, when irradiated with light output from the scintillator 33 irradiated with radiation, absorbs light energy to generate electron-hole pairs therein, thereby converting the light energy into electric charges.

In each small region R, one thin film transistor 31g is provided for each photoelectric conversion element 31f. The source electrode of the thin film transistor 31g is connected to one electrode of the photoelectric conversion element 31f, the drain electrode of the thin film transistor 31g is connected to the signal line 31c, and the gate electrode of the thin film transistor 31g is connected to the scanning line 31b.

As illustrated in FIG. 3, the optical adhesive layer 32 is provided between the element substrate 31 and the scintillator 33 and bonds the element substrate 31 and the scintillator 33 together. The optical adhesive layer 32 is formed of an optical adhesive. Examples of the optical adhesive include thermoplastic resins or the like whose main component is olefin-based, amide-based, ester-based, styrene-based, acryl-based, urethane-based, vinyl-based, polycarbonate, or ABS resin (acrylonitrile-butadiene-styrene copolymer resin).

The scintillator 33 converts incident radiation into light having another wavelength. The scintillator 33 contains a phosphor as a main component. As the phosphor, for example, a phosphor in which an emission center substance is activated in a base material such as thallium-activated cesium iodide (CsI:Tl), sodium-activated cesium iodide (CsI:Na), or terbium-activated gadolinium oxysulfide (GOS) is preferably used.

The scintillator 33 is formed in a rectangular plate shape and is attached to the scintillator substrate 34.

The scintillator substrate 34 is formed of a flexible material in a rectangular plate shape.

The moisture-proof layer 35 prevents the scintillator 33 from absorbing moisture.

The moisture-proof layer 35 is formed in a sheet shape with a material having a property of not allowing moisture to pass therethrough, such as an aluminum-evaporated resin.

A part of the moisture-proof layer 35 being in contact with the scintillator substrate 34 is bonded to the scintillator substrate 34 via an adhesive layer (not illustrated).

As described above, the radiation detection section 3 includes the scintillator 33, a light detection section (light detector) having a light receiving surface (front surface 31a) on which the light receiving elements (photoelectric conversion elements 31f) and the lines (signal lines 31c) for reading out electric signals from the light receiving elements are formed, and the support (element substrate 31) for supporting the light detection section.

The radiation detection section 3 may be of a direct conversion type in which the scintillator 33 is not included and an element(s) that directly converts radiation into electric charges is disposed on the element substrate 31.

The radiation detection section 3 may include a shield layer for shielding noise generated by a circuit board 52, which will be described later, between the radiation detection section 3 and the first adhesive member 6. The shield layer is, for example, a metal thin film, a resin film having a metal layer formed on its surface, or a film formed of a transparent conductive material (e.g., indium tin oxide (ITO)).

### 2-2. Holding Base

The holding base 4 holds the radiation detection section 3. This “hold” means not only supporting the radiation detection section 3 against the load received from the front surface part 11 side but also providing the radiation detection section 3 on the holding base 4.

As illustrated in FIG. 2, the holding base 4 is provided between the first adhesive member 6 and the back surface part 21. Since the holding base 4 disperses the load applied to the housing 110 from the outside, it is possible to suppress the bending of the radiation detection section 3.

The holding base 4 has a rectangular flat plate shape, and is formed of a magnesium alloy, which is lightweight and has relatively high strength. The material of the holding base 4 may be a light metal such as aluminum, or an alloy thereof.

As illustrated in FIG. 2, the holding base 4 includes a planar part 4a and leg-like parts 4b.

### 2-2-1. Planar Part

The planar part 4a has a predetermined thicknesses in the Z-axis direction, and is provided along, of the first adhesive member 6, the surface closer to the back surface part 21 without space therebetween. Since the holding base 4 further disperses the load applied to the housing 110 from the outside, it is possible to further suppress the bending of the radiation detection section 3.

The planar part 4a has one surface that is in contact with the first adhesive member 6 and the other surface that is in contact with a battery 54 and the like. Hereinafter, the one surface of the planar part 4a to be in contact with the first adhesive member 6 is referred to as a holding surface 41a. The holding surface 41a is slightly larger than the radiation detection section 3. Therefore, the planar part 4a can support the entire radiation detection section 3.

For example, a gap of 1 mm or more is provided between the lateral surface of the planar part 4a in the Y-axis direction and the lateral surface part 12 and between the lateral surface of the planar part 4a in the X-axis direction and the lateral surface part 12. Thus, it is possible to prevent propagation of an external impact to the internal module 120.

On an opposite surface 41a, which is a surface opposite to the holding surface 41b of the planar part 4a, female screws (not illustrated) for attaching the circuit board 52 and the like are provided. In a case where the material of the holding base 4 is metal, male screws can be directly formed on the planar part 4a, and thus the radiographic imaging apparatus 100 can be easily manufactured.

### 2-2-2. Leg-like Part

As illustrated in FIG. 2, the leg-like parts 4b are provided so as to protrude from the opposite surface 4a of the planar part 41b to abut the back surface part 21. Thus, the holding base 4 can be held and a load from the front surface part 11 side in the radiographic imaging apparatus 100 can be borne.

### 2-2-3. Holding Base, etc.

As illustrated in FIG. 2, the planar part 4a and the leg-like parts 4b constitute recesses 4c.

The circuit board 52, the battery 54 and the like are stored in the recesses 4c. The width, the length and the depth (width in the Z-axis direction) of the recesses 4c are those capable of storing the circuit board 52, the battery 54 and the like. The depth of the recesses 4c is greater than the width of the circuit board 52, including elements on the circuit board 52, in the Z-axis direction.

### 2-3. Electric Component

As illustrated in FIG. 1 and FIG. 2, the electric component 5 includes the connector 51, the circuit board 52, a line 53, the battery 54, the antenna 56, the operation part 57, and a readout IC 58.

The connector 51 can supply electric power from an external apparatus by wired connection and can be connected to an external connector for communicating with an external apparatus. The connector 51 is connected to the circuit board 52 and outputs electric power and communication signals from the outside to the circuit board 52.

The antenna 56 performs wireless communication with an external apparatus. The antenna 56 is connected to the circuit board 52 and outputs communication signals from the outside to the circuit board 52.

The operation part 57 is a switch such as a power switch or a changeover switch. The operation part 57 is connected to the circuit board 52 and outputs input operation signals to the circuit board 52.

The readout IC 58 converts output signals from the radiation detection section 3 into image data.

### 2-3-1. Circuit Board

The circuit board 52 and the back surface part 21 are separate from each other. As a result, it is possible to suppress the load applied to the housing 110 from the outside from being conveyed to the circuit board 52.

Various electronic circuits are mounted on the circuit board 52. The circuit board 52 includes an SIF substrate, a control substrate, a substrate on which a wireless communication circuit is mounted, and a substrate on which a power supply circuit is mounted.

The SIF substrate is connected to the radiation detection section 3 via the line 53, and reads out output signals of the radiation detection section 3 through the line 53 and the readout IC 58 provided thereon.

The control substrate controls the circuits to generate image data.

The wireless communication circuit is a circuit for wirelessly communicating with another apparatus.

The power supply circuit is a circuit for applying a voltage to a semiconductor element and supplying electric power to the above-described circuits.

### 2-3-2. Line

The line 53 is formed of, for example, a flexible printed circuit. The wire 53 connects terminals of the signal lines (photoelectric conversion elements 31f) of the radiation detection section 3, the readout IC 58, and the circuit board 52.

### 2-3-3. Battery

The battery 54 supplies electric power to each component of the radiographic imaging apparatus 100. In the present embodiment, the battery 54 is a lithium ion capacitor, but may be a lithium ion battery, another rechargeable battery, or the like. A plurality of batteries 54 may be provided.

### 2-4. Vibration Damping Member

The vibration damping member 8 suppresses vibration of the readout IC 58.

The vibration damping member 8 is arranged between the line 53 and the back surface part 21 at a position facing the readout IC 58 with the line 53 in between.

### 2-5. First Adhesive Member

As illustrated in FIG. 3, the first adhesive member 6 includes adhesive layers 61 and 63 and a buffer material 62.

The adhesive layers 61 and 63 are each an adhesive, an adhesive tape, or the like.

The buffer material 62 is provided between the adhesive layer 61 and the adhesive layer 63 and is for absorbing a load or an impact from the outside.

The first adhesive member 6 is provided between the radiation detection section 3 and the holding base 4. Thus, the load, the impact and the like received from the back surface part 21 side can be prevented from being conveyed to the radiation detection section 3.

The adhesive layers 61 and 63 and the buffer material 62 may have an antistatic property.

### 2-6. Second Adhesive Member

As illustrated in FIG. 3, the second adhesive member 7 includes an adhesive layer 71 disposed on the front surface part 11 side, a buffer material 72, and a peelable adhesive layer 73 disposed on the peeling aid 9 side.

The adhesive layer 71 and the peelable adhesive layer 73 are each an adhesive, an adhesive tape, or the like.

The adhesive force of the peelable adhesive layer 73 is smaller than the adhesive force of the adhesive layer 71, and is large to the extent that peeling from the peeling aid 9 due to disturbance does not occur. The peelable adhesive layer 73 is not peeled off from the peeling aid 9 during use of the radiographic imaging apparatus 100. On the other hand, the peelable adhesive layer 73 can be peeled from the peeling aid 9 when the internal module 120 is peeled off from the front surface part 11 (reworked).

The adhesive force of the peelable adhesive layer 73 is smaller than the adhesive force of the adhesive with which the members stacked inside the radiation detection section 3 are bonded together. Thus, when the internal module 120 is peeled off from the front surface part 11, it is possible to prevent the stacked layers in the radiation detection section 3 from being peeled off by defeated by the peeling force.

In the second adhesive member 7, the adhesive layer 71 may be disposed on the peeling aid 9 side, and the peelable adhesive layer 73 may be disposed on the front surface part 11 side. In this case, the peelable adhesive layer 73 can be peeled off from the front surface part 11 when the internal module 120 is peeled off from the front surface part 11 (reworked).

The buffer material 72 is provided between the adhesive layer 71 and the peelable adhesive layer 73 and absorbs a load or an impact from the outside. The second adhesive member 7 is provided between the front surface part 11 of the housing 110 and the peeling aid 9. Thus, it is possible to prevent a load, an impact, or the like received from the front surface part 11 side from being conveyed to the radiation detection section 3 via the peeling aid 9.

The adhesive layer 71, the buffer material 72 and the peelable adhesive layer 73 may have an antistatic property.

The first adhesive member 6 and the second adhesive member 7 may have different configurations as in the present embodiment or may have the same configuration.

### 2-7. Peeling Aid

The peeling aid 9 is arranged between the radiation detection section 3 and the second adhesive member 7 and includes a film material 91 and an adhesive layer 92. The film material 91 is formed of resin such as PET, PC, or oriented polypropylene (OPP).

The adhesive layer 92 is an adhesive, an adhesive tape, or the like, and fixes the peeling aid 9 to the radiation detection section 3. That is, the peeling aid 9 is fixed to the inner surface of the irradiation part (front surface part 11) by the second adhesive member 7, between the internal module 120 and the front surface part 11.

The peeling aid 9 of the first embodiment is provided over the entire region of the surface (anterior surface 3a) of the radiation detection section 3 closer to the front surface part 11. In other words, the peeling aid 9 of the first embodiment is provided on the entire surface of the internal module 120 closer to the irradiation part (front surface part 11). The peeling aid 9 of the first embodiment has a lower bending rigidity than that of the internal module 120 and is bendable when a load such as an external force is applied thereto.

The peeling aid 9 is configured to be graspable when the internal module 120 is peeled off from the front surface part 11. Since force can be easily applied to the internal module 120 by the peeling aid 9, the internal module 120 can be easily peeled off from the front surface part 11. When stored in the housing 110, the peeling aid 9 is stored in a state of being folded to the internal module 120 side.

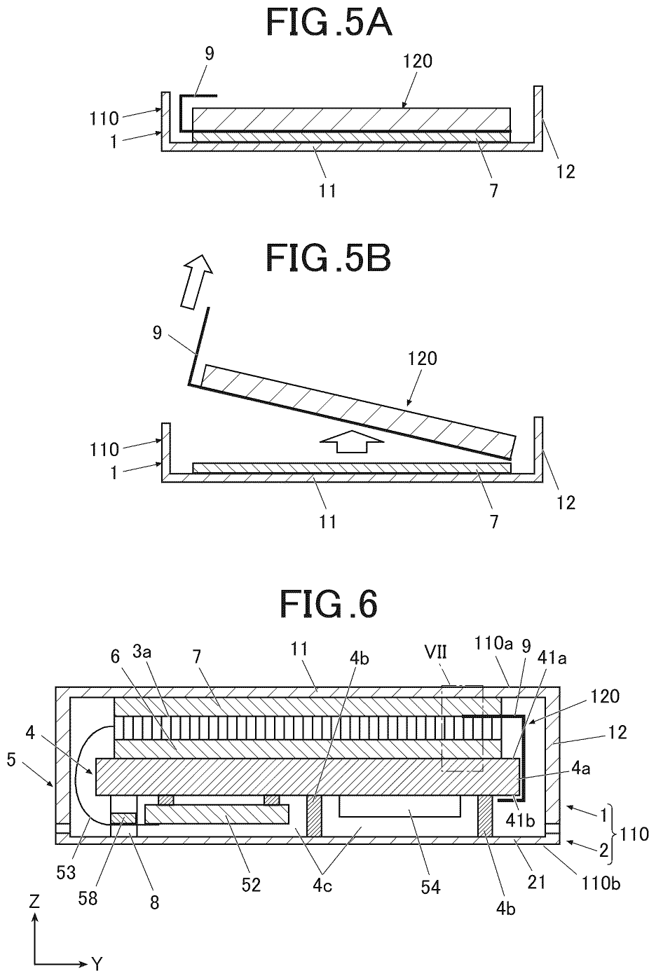

When peeling off the internal module 120 from the front surface part 11, as illustrated in FIG. 5A, the user removes the lid 2 and turns over the case 1. Next, the user grips the folded peeling aid 9 and pulls it in the peeling direction (upward in FIG. 5B) as illustrated in FIG. 5B. Thus, the internal module 120 can be easily peeled off from the front surface part 11.

The gripping part(s) of the peeling aid 9 may be fixed to the holding base 4 with an adhesive, an adhesive tape, a mechanical fastener, or the like. Thus, by suppressing the peeling electrification generated by the movement of the gripping part of the peeling aid 9 in the housing 110, noise to the electric component 5 can be prevented.

Since the peeling aid 9 of the first embodiment is provided on the entire surface of the internal module 120 closer to the front surface part 11, the adhesion area of the peeling aid 9 and the internal module 120 becomes larger. Therefore, when the internal module 120 is peeled off from the front surface part 11, pulling the peeling aid 9 can prevent the peeling aid 9 itself from being peeled off from the internal module 120. Therefore, the internal module 120 can be easily peeled off from the front surface part 11.

Since the peeling aid 9 of the first embodiment is provided on the entire surface of the internal module 120 closer to the front surface part 11, even when a load is applied to the front surface part 11, the radiation detection section 3 is not locally bent due to the peeling aid 9. Therefore, a local step is not generated in the radiation detection section 3, and thus it is possible to suppress occurrence of disturbance (image unevenness) in an image generated by the radiographic imaging apparatus 100. The radiation detection section 3 can be prevented from being damaged.

### Second Embodiment

Next, a second embodiment of the present invention will be described. Hereinafter, different points from the first embodiment are mainly described.

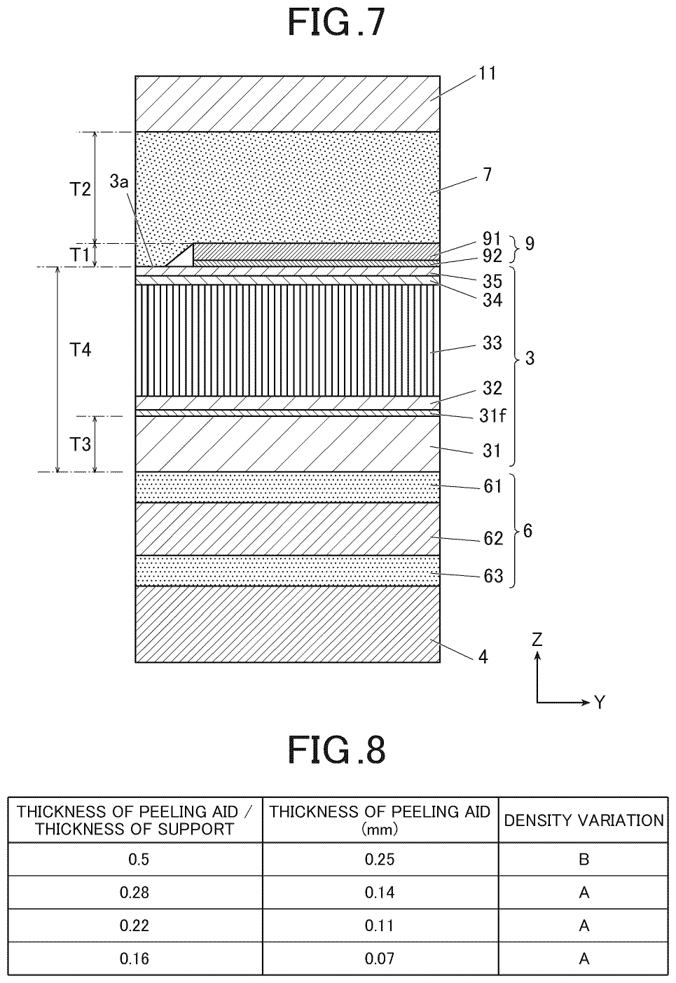

FIG. 6 is a schematic diagram of a section along line II-II of the radiographic imaging apparatus 100 of the second embodiment. FIG. 7 illustrates a partial sectional view VII of FIG. 6.

As illustrated in FIG. 6 and FIG. 7, the peeling aid 9 of the second embodiment is provided, in the Y-axis direction, only on part of the surface (anterior surface 3a) of the radiation detection section 3 closer to the front surface part 11. In other words, the peeling aid 9 of the second embodiment is provided on part of the surface of the internal module 120 closer to the irradiation part (front surface part 11).

Of the anterior surface 3a, the part where the peeling aid 9 is not provided is fixed to the inner surface of the irradiation part (front surface part 11) by the second adhesive member 7 to be peelable.

By providing the peeling aid 9 only on part of the anterior surface 3a in the Y-axis direction, the size of the peeling aid 9 can be smaller than that of the peeling aid 9 of the first embodiment. Therefore, the weight of the radiographic imaging apparatus 100 can be reduced, and/or the cost of the radiographic imaging apparatus 100 can be reduced.

In the radiographic imaging apparatus 100 of the first embodiment, the radiation detection section 3 and the front surface part 11 are fixed via the second adhesive member 7 and the peeling aid 9. Meanwhile, in the radiographic imaging apparatus 100 of the second embodiment, the radiation detection section 3 and the front surface part 11 are fixed by the second adhesive member 7 alone by making the attachment area of the peeling aid 9 smaller than that of the first embodiment. Thus, functions can be divided for the second adhesive member 7 and the peeling aid 9, and therefore the second adhesive member 7 and the peeling aid 9 can be formed of materials optimized for their respective functions.

The attachment area of the peeling aid 9 is desirably about 6% of the width of the anterior surface 3a in the Y-axis direction from the end in order to be a sufficient attachment area and suppress the influence of weight, cost, and the like. However, by adjusting the adhesive force, adhesion area, thickness, and the like of the adhesive layer 92, the function of the peeling aid 9 can be satisfied even if the width of the attachment area of the peeling aid 9 is larger or smaller than 6%.

The width of the peeling aid 9 of the second embodiment in the X-axis direction is substantially the same as the width of the radiation detection section 3 in the X-axis direction. Thus, it is possible to secure the adhesion area of the peeling aid 9 and the internal module 120 to the extent that pulling the peeling aid 9 when the internal module 120 is peeled off from the front surface part 11 can prevent the peeling aid 9 itself from being peeled off from the internal module 120.

The width of the peeling aid 9 of the second embodiment in the X-axis direction may be smaller than the width of the radiation detection section 3 in the X-axis direction. That is, the peeling aid 9 of the second embodiment may be provided on only part of the anterior surface 3a in the X-axis direction. In this case, the area of the peeling aid 9 becomes further smaller, and thus the weight of the radiographic imaging apparatus 100 can be reduced.

The thickness T1 (dimension in the Z-axis direction) of the peeling aid 9 of the second embodiment is less than the thickness T2 of the second adhesive member 7. Thus, even if a load is applied to the front surface part 11, the bending due to the peeling aid 9 can be absorbed by the contraction of the second adhesive member 7 in the Z-axis direction. Therefore, a local step is not generated in the radiation detection section 3, and thus it is possible to suppress occurrence of disturbance (image unevenness) in an image generated by the radiographic imaging apparatus 100. The radiation detection section 3 can be prevented from being damaged.

In a case where the thickness Tl of the peeling aid 9 is greater than or equal to the thickness T2 of the second adhesive member 7, the part of the second adhesive member 7 overlapping the peeling aid 9 in the Z-axis direction is in a state of contracting in the Z-axis direction even in a state in which no load is applied to the front surface part 11. Therefore, when a load is applied to the front surface part 11, the second adhesive member 7 cannot absorb the bending due to the peeling aid 9. Therefore, a local step is generated in the radiation detection section 3, and thus disturbance (image unevenness) occurs in an image generated by the radiographic imaging apparatus 100. When local bending repeatedly occurs in the radiation detection section 3, the radiation detection section 3 may be damaged.

### Third Embodiment

Next, a third embodiment of the present invention will be described. Hereinafter, different points from the second embodiment will be mainly described.

The element substrate 31 of the radiation detection section 3 of the third embodiment is formed of a glass substrate.

The thickness T1 (width in the Z-axis direction) of the peeling aid 9 of the third embodiment is less than half the thickness T3 (in FIG. 7) of the support (element substrate 31).

Hereinafter, the above-described configuration of the third embodiment will be described.

The amount of bending of the radiation detection section 3 in a case where a load is applied to the front surface part 11 or the like becomes smaller as the bending rigidity of the radiation detection section 3 becomes higher. The bending rigidity of the radiation detection section 3 is greatly affected by the bending rigidity of the support (element substrate 31). That is, in a case where the element substrate 31 is formed of a glass substrate, the bending rigidity of the radiation detection section 3 is higher than that in a case where the element substrate 31 is formed of a flexible material, and thus the bending amount of the radiation detection section 3 is small.

Meanwhile, as the peeling aid 9 becomes thicker, the local bending amount of the radiation detection section 3 when the load is applied to the front surface part 11 increases.

FIG. 8 illustrates the relationship between the thickness of the peeling aid 9 and the thickness of the support (element substrate 31). The example illustrated in FIG. 8 is a case where the element substrate 31 formed of glass is 0.5 mm thick. In the example illustrated in FIG. 8, a case where the density variation in an image (captured image) generated by the radiographic imaging apparatus 100 is equal to or less than a reference value is defined as A. A case where the density variation in a captured image is equal to or less than the reference value is a case where the captured image is not adversely affected. Meanwhile, a case where the density variation of a captured image is more than the reference value is defined as B. When the density variation of a captured image is more than the reference value, the captured image may be adversely affected.

As illustrated in FIG. 8, in order to suppress the bending amount of the radiation detection section 3 to the extent of not adversely affecting a captured image, the ratio of the thickness of the peeling aid 9 to the thickness of the element substrate 31 needs to be less than 0.5. The ratio of the thickness of the peeling aid 9 to the thickness of the element substrate 31 is a value obtained by dividing the thickness of the peeling aid 9 by the thickness of the element substrate 31. That is, the thickness T1 of the peeling aid 9 needs to be less than half the thickness T3 of the element substrate 31.

As described above, in the third embodiment, the bending amount of the radiation detection section 3 due to the peeling aid 9 can be suppressed to the extent of not affecting a captured image even when a load is applied to the front surface part 11. That is, it is possible to suppress occurrence of disturbance (image unevenness) in a captured image. Suppressing the bending amount of the radiation detection section 3 can prevent the radiation detection section 3 from being damaged.

### Fourth Embodiment

Next, a fourth embodiment of the present invention will be described. Hereinafter, different points from the second embodiment will be mainly described.

The element substrate 31 of the radiation detection section 3 of the fourth embodiment is formed of a flexible material. Thus, the radiation detection section 3 has flexibility.

The thickness T1 (width in the Z-axis direction) of the peeling aid 9 of the fourth embodiment is less than half the thickness T4 (in FIG. 7) of the radiation detection section 3.

Hereinafter, the above-described configuration of the fourth embodiment will be described.

The flexible radiation detection section 3 of the fourth embodiment has a smaller bending rigidity than the radiation detection section 3, which has the element substrate 31 formed of glass, of the third embodiment, and thus is easily bent. Therefore, it is necessary to consider the bending rigidity of the entire radiation detection section 3 including the element substrate 31, the optical adhesive layer 32, the scintillator 33, the scintillator substrate 34, and the moisture-proof layer 35.

In order to suppress the bending amount of the radiation detection section 3 to the extent of not affecting a captured image, it is necessary that the thickness T1 of the peeling aid 9 is less than half the thickness T3 of the radiation detection section 3.

As described above, in the fourth embodiment, the bending amount of the radiation detection section 3 due to the peeling aid 9 can be suppressed to the extent of not affecting a captured image even when a load is applied to the front surface part 11. That is, it is possible to suppress occurrence of disturbance (image unevenness) in a captured image. Suppressing the bending amount of the radiation detection section 3 can prevent the radiation detection section 3 from being damaged.

### Fifth Embodiment

Next, a fifth embodiment of the present invention will be described. Hereinafter, different points from the second embodiment will be mainly described.

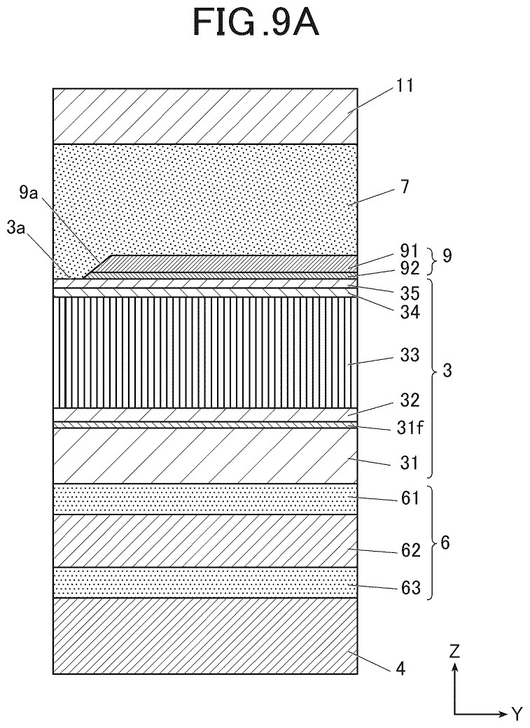

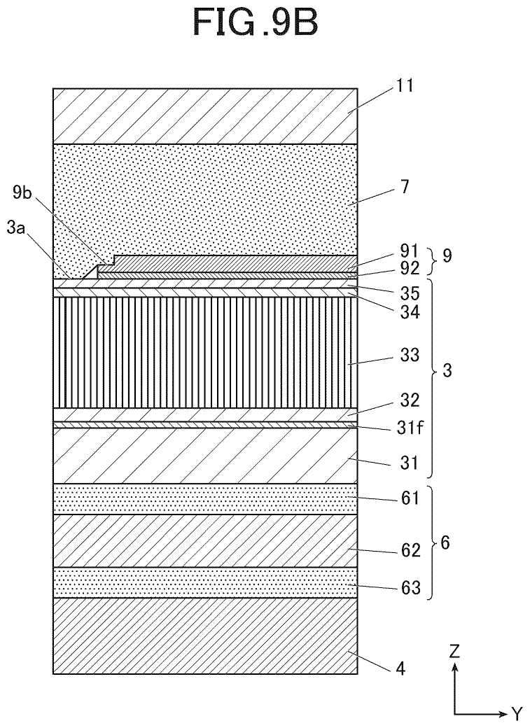

FIG. 9A and FIG. 9B illustrate a partial sectional view VII of FIG. 6 in the fifth embodiment.

As illustrated in FIG. 9A, the peeling aid 9 of the fifth embodiment has a gradually-decreasing part 9a whose end part on the radiation detection section 3 becomes gradually thinner toward the distal end of the end part. In other words, the peeling aid 9 of the fifth embodiment has a shape in which the thickness of the end part on the internal module 120 gradually decreases toward the distal end of the end part.

Alternatively, as illustrated in FIG. 9B, the peeling aid 9 of the fifth embodiment has a stepped part 9b whose end part on the radiation detection section 3 becomes thinner stepwise toward the distal end of the end part. In other words, the peeling aid 9 of the fifth embodiment has a shape in which the thickness of the end part on the internal module 120 decreases stepwise toward the distal end of the end part.

As described above, in the fifth embodiment, since the peeling aid 9 has the gradually-decreasing part 9a or the stepped part 9b, even if a load is applied to the front surface part 11, the peeling aid 9 can make a step generated in the radiation detection section 3 gentle to the extent that the step does not affect a captured image. Therefore, it is possible to suppress occurrence of disturbance (image unevenness) in an image generated by the radiographic imaging apparatus 100. By making a step generated in the radiation detection section 3 gentle, it is possible to prevent the radiation detection section 3 from being damaged.

### 3. Advantageous Effects

As described above, the radiographic imaging apparatus 100 of the present embodiment(s) includes the housing 110 having the irradiation part (front surface part 11) to be irradiated with radiation.

The radiographic imaging apparatus 100 of the present embodiment(s) includes the internal module 120 including the radiation detection section 3 that detects the radiation and the holding base 4 that is made of metal and holds the radiation detection section 3.

The radiographic imaging apparatus 100 of the present embodiment(s) includes the peeling aid 9 that has a lower bending rigidity than that of the internal module 120 and is disposed between the internal module 120 and the irradiation part.

The radiation detection section 3 includes the scintillator 33, the light detection section having the light receiving surface (front surface 31a) on which the light receiving elements (photoelectric conversion elements 31f) and the lines (signal lines 31c) for reading out electric signals from the light receiving elements are formed, and the support (element substrate 31) for supporting the light detection section.

The peeling aid 9 is provided on the entire surface of the internal module 120 closer to the irradiation part and is fixed to the inner surface of the irradiation part to be peelable by an adhesive member (second adhesive member 7).

Since the peeling aid 9 is provided on the entire surface of the internal module 120 closer to the front surface part 11, even if a load is applied to the front surface part 11, the radiation detection section 3 is not locally bent due to the peeling aid 9. Therefore, a local step is not generated in the radiation detection section 3, and thus it is possible to suppress occurrence of disturbance (image unevenness) in an image generated by the radiographic imaging apparatus 100. The radiation detection section 3 can be prevented from being damaged.

The radiographic imaging apparatus 100 of the present embodiment(s) includes the housing 110 having the irradiation part (front surface part 11) to be irradiated with radiation.

The radiographic imaging apparatus 100 of the present embodiment(s) includes the internal module 120 including the radiation detection section 3 that is fixed to the inner surface of the irradiation part by an adhesive member (second adhesive member 7) to be peelable and detects radiation and the holding base 4 that is made of metal and holds the radiation detection section 3.

The radiographic imaging apparatus 100 of the present embodiment(s) includes the peeling aid 9 disposed between the internal module 120 and the irradiation part.

The radiation detection section 3 includes the scintillator 33, the light detection section having the light receiving surface (front surface 31a) on which the light receiving elements (photoelectric conversion elements 31f) and the lines (signal lines 31c) for reading out electric signals from the light receiving elements are formed, and the support (element substrate 31) for supporting the light detection section.

The peeling aid 9 is provided on part of the surface of the internal module 120 closer to the irradiation part.

The thickness of the peeling aid 9 is less than that of the adhesive member.

Therefore, even if a load is applied to the front surface part 11, the bending due to the peeling aid 9 can be absorbed by the contraction of the second adhesive member 7 in the Z-axis direction. Therefore, a local step is not generated in the radiation detection section 3, and thus it is possible to suppress occurrence of disturbance (image unevenness) in an image generated by the radiographic imaging apparatus 100. The radiation detection section 3 can be prevented from being damaged.

The radiographic imaging apparatus 100 of the present embodiment(s) includes the housing 110 having the irradiation part (front surface part 11) to be irradiated with radiation.

The radiographic imaging apparatus 100 of the present embodiment(s) includes the internal module 120 including the radiation detection section 3 that is fixed to the inner surface of the irradiation part by an adhesive member (second adhesive member 7) to be peelable and detects radiation and the holding base 4 that is made of metal and holds the radiation detection section 3.

The radiographic imaging apparatus 100 of the present embodiment(s) includes the peeling aid 9 disposed between the internal module 120 and the irradiation part.

The radiation detection section 3 includes the scintillator 33, the light detection section having the light receiving surface (front surface 31a) on which the light receiving elements (photoelectric conversion elements 31f) and the lines (signal lines 31c) for reading out electric signals from the light receiving elements are formed, and the support (element substrate 31) made of glass for supporting the light detection section.

The peeling aid 9 is provided on part of the surface of the internal module 120 closer to the irradiation part.

The thickness of the peeling aid 9 is less than half the thickness of the support.

Therefore, the bending amount of the radiation detection section 3 due to the peeling aid 9 can be suppressed to the extent of not affecting a captured image even when a load is applied to the front surface part 11. That is, it is possible to suppress occurrence of disturbance (image unevenness) in a captured image. Suppressing the bending amount of the radiation detection section 3 can prevent the radiation detection section 3 from being damaged.

The radiographic imaging apparatus 100 of the present embodiment(s) includes the housing 110 having the irradiation part (front surface part 11) to be irradiated with radiation.

The radiographic imaging apparatus 100 of the present embodiment(s) includes the internal module 120 including the radiation detection section 3 that is fixed to the inner surface of the irradiation part by an adhesive member (second adhesive member 7) to be peelable and detects radiation and the holding base 4 that is made of metal and holds the radiation detection section 3.

The radiographic imaging apparatus 100 of the present embodiment(s) includes the peeling aid 9 disposed between the internal module 120 and the irradiation part.

The radiation detection section 3 includes the scintillator 33, the light detection section having the light receiving surface (front surface 31a) on which the light receiving elements (photoelectric conversion elements 31f) and the lines (signal lines 31c) for reading out electric signals from the light receiving elements are formed, and the fixable support (element substrate 31) for supporting the light detection section.

The peeling aid 9 is provided on part of the surface of the internal module 120 closer to the irradiation part.

The thickness of the peeling aid 9 is less than half the thickness of the radiation detection section 3.

Therefore, the bending amount of the radiation detection section 3 due to the peeling aid 9 can be suppressed to the extent of not affecting a captured image even when a load is applied to the front surface part 11. That is, it is possible to suppress occurrence of disturbance (image unevenness) in a captured image. Suppressing the bending amount of the radiation detection section 3 can prevent the radiation detection section 3 from being damaged.

The radiographic imaging apparatus 100 of the present embodiment(s) includes the housing 110 having the irradiation part (front surface part 11) to be irradiated with radiation.

The radiographic imaging apparatus 100 of the present embodiment(s) includes the internal module 120 including the radiation detection section 3 that is fixed to the inner surface of the irradiation part by an adhesive member (second adhesive member 7) to be peelable and detects radiation and the holding base 4 that is made of metal and holds the radiation detection section 3.

The radiographic imaging apparatus 100 of the present embodiment(s) includes the peeling aid 9 disposed between the internal module 120 and the irradiation part.

The radiation detection section 3 includes the scintillator 33, the light detection section having the light receiving surface (front surface 31a) on which the light receiving elements (photoelectric conversion elements 31f) and the lines (signal lines 31c) for reading out electric signals from the light receiving elements are formed, and the support (element substrate 31) for supporting the light detection section.

The peeling aid 9 is provided on a part of the surface of the internal module 120 closer to the irradiation part, and has a shape in which the thickness of the end part on the internal module 120 gradually decreases or decreases stepwise toward the distal end of the end part.

Therefore, even when a load is applied to the front surface part 11, a step generated in the radiation detection section 3 due to the peeling aid 9 can be made gentle to the extent that the step does not affect a captured image. Therefore, it is possible to suppress occurrence of disturbance (image unevenness) in an image generated by the radiographic imaging apparatus 100. By making a step generated in the radiation detection section 3 gentle, it is possible to prevent the radiation detection section 3 from being damaged.

In the radiographic imaging apparatus 100 of the present embodiment(s), the peeling aid 9 is a film formed of resin.

As a result, the weight of the radiographic imaging apparatus 100 can be reduced.

The present invention is not limited to the above embodiments, and various modifications can be made.

For example, in the above embodiments, the radiation detection section 3 is configured such that the scintillator 33 is disposed on the positive side of the Z-axis direction, and the light detection section having the light receiving surface (front surface 31a) on which the light receiving elements (photoelectric conversion elements 31f) and the lines (signal lines 31c) for reading out electric signals from the light receiving elements is disposed on the negative side of the Z-axis direction, but not limited thereto. The radiation detection section 3 may be configured such that the light detection section is disposed on the positive side of the Z-axis direction, and the scintillator 33 is disposed on the negative side of the Z-axis direction.

In the above embodiments, the peeling aid 9 is provided between the second adhesive member 7 and the radiation detection section 3, but not limited thereto. The peeling aid 9 may be provided between the front surface part 11 and the second adhesive member 7. In this case too, since force can be easily applied to the internal module 120 by the peeling aid 9, the internal module 120 can be easily peeled off from the front surface part 11.

Besides, the specific configuration, contents and procedure of operation, and the like described in the above embodiments can be appropriately changed without departing from the scope of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. A radiographic imaging apparatus comprising:
a housing having an irradiation part to be irradiated with radiation;
an internal module including:
a radiation detector that detects the radiation; and
a holding base that is made of metal and holds the radiation detector; and
a peeling aid having a bending rigidity lower than a bending rigidity of the internal module and disposed between the internal module and the irradiation part,
wherein the radiation detector includes:
a scintillator;
a light detector having a light receiving surface on which a light receiving element and a line for reading out an electric signal from the light receiving element are formed; and
a support that supports the light detector, and
wherein the peeling aid is provided on, of the internal module, an entire surface closer to the irradiation part, and fixed to an inner surface of the irradiation part by an adhesive member to be peelable.

2. A radiographic imaging apparatus comprising:
a housing having an irradiation part to be irradiated with radiation;
an internal module including:
a radiation detector that is fixed to an inner surface of the irradiation part by an adhesive member to be peelable and detects the radiation; and
a holding base that is made of metal and holds the radiation detector; and
a peeling aid disposed between the internal module and the irradiation part,
wherein the radiation detector includes:
a scintillator;
a light detector having a light receiving surface on which a light receiving element and a line for reading out an electric signal from the light receiving element are formed; and
a support that supports the light detector,
wherein the peeling aid is provided on, of the internal module, a part of a surface closer to the irradiation part, and
wherein a thickness of the peeling aid is less than a thickness of the adhesive member.

3. A radiographic imaging apparatus comprising:
a housing having an irradiation part to be irradiated with radiation;
an internal module including:
a radiation detector that is fixed to an inner surface of the irradiation part by an adhesive member to be peelable and detects the radiation; and
a holding base that is made of metal and holds the radiation detector; and
a peeling aid disposed between the internal module and the irradiation part,
wherein the radiation detector includes:
a scintillator;
a light detector having a light receiving surface on which a light receiving element and a line for reading out an electric signal from the light receiving element are formed; and
a support that is made of glass and supports the light detector,
wherein the peeling aid is provided on, of the internal module, a part of a surface closer to the irradiation part, and
wherein a thickness of the peeling aid is less than half of a thickness of the support.

4. The radiographic imaging apparatus according to claim 1, wherein the peeling aid is a film made of resin.

5. The radiographic imaging apparatus according to claim 2, wherein the peeling aid is a film made of resin.

6. The radiographic imaging apparatus according to claim 3, wherein the peeling aid is a film made of resin.
